(19) United States
(12) Patent Application Publication
(10) Pub. No.: US 2007/0106714 A1
(43) Pub. Date: May 10, 2007

(54) METHOD AND SYSTEM USING AN EXTERNAL HARD DRIVE TO IMPLEMENT BACK-UP FILES

(76) Inventor: James N. Rothbarth, St. Louis, MO (US)

Correspondence Address: SENNIGER POWERS, ONE METROPOLITAN SQUARE, 16TH FLOOR, ST LOUIS, MO, 63102, US

(21) Appl. No.: 11/617,106

(22) Filed: Dec. 28, 2006

Related U.S. Application Data
(63) Continuation-in-part of application No. 10/814,683, filed on Mar. 31, 2004.
Application No. 10/814,683 is a continuation-in-part of application No. 10/682,355, filed on Oct. 9, 2003.
(60) Provisional application No. 60/417,448, filed on Oct. 10, 2002.

(51) Int. Cl. G06F 17/30

(52) U.S. Cl. 707/204

(57) ABSTRACT

A method for transferring back-up copies of first files from a first computer to an external hard drive (EHD) and optionally for transferring back up copies of second files from a second computer to the EHD. A system uses a server to back up first files on a first computer which is periodically connected to a network.

### FIELD OF THE INVENTION

The invention relates to a system and method in which a user backs-up computer files to a remote external hard drive. In particular, the invention relates to a system and method for selectively transferring encrypted copies of files from an originating computer to storage space on an external hard drive connected to another computer which is networked to the originating computer.

### BACKGROUND OF THE INVENTION

It is common practice for computer users to store computer file data on computer readable medium (CRM) such as CD-ROMs, digital versatile disks (DVD), magnetic cassettes, magnetic tape, magnetic disk storage, or magnetic hard disk drives. However, data stored on such storage devices can be lost due to fire, flood, theft, or any other event that adversely affects the storage medium. Therefore, it is often wise to generate a back-up copy of computer file data for storage at an off-site location in order to prevent destruction of both the original data and the back-up copy by the same catastrophic event.

However, current methods of generating and maintaining back-up copies of file data are often inefficient. For example, some existing back-up operations involve creating a copy of all the data stored on the CRM. Although this method provides complete protection, it can be time consuming and can cause unnecessary wear on the mechanical components of the disk drive. Moreover, storage space could be saved at the back-up site by allowing the user at the origination site to designate one or more files for storage at a destination site.

Some systems require physically transporting the storage medium containing the back-up copy to the back-up site. Such transportation may lead to further expense and opportunities for media damage. In addition, these prior methods do not provide an efficient system and method for retrieving the stored data from the off-site location.

Moreover, prior online data storage systems are located at known sites on the Internet, and are therefore vulnerable to attack from malicious persons (i.e., hackers) attempting to access and/or modify data stored on such systems. In particular, these existing storage systems do not allow computer users to communicate with other computer users via a communication network, such as the Internet, for the purpose of storing back-up data on the other's computer.

Thus, the need exists for a method and system for securely transmitting copies of data to a remote back-up site for storage, for retrieving copies of the previously stored data from the remote back-up site, and for verifying the transported data. A need also exists for a back-up system in which additional equipment is not required and one or more users share storage space on their computers. A need also exists to make it more difficult, if not impossible, for malicious users to identify a remote back-up site for particular users.

### SUMMARY OF THE INVENTION

In one embodiment, the invention is a method for transferring back-up copies of first files from a first computer to an external hard drive (EHD), wherein an Internet connection periodically connects to the first computer. The method comprises:

Copying a file manager to the EHD;

Connecting the EHD including the file manager to the first computer wherein the file manager is copied to the first computer and wherein the file manager backs up the first files to the EHD; and

Connecting the EHD including the file manager to a remote computer connected to the Internet wherein the copy of the file manager on the first computer backs up the first files to the EHD via the Internet connection between the first computer and the remote computer.

In one embodiment, the invention is a system to back up first files on a first computer which is periodically connected to a network which is connected to a second computer. The system comprises an external hard drive (EHD); a file manager on the EHD wherein the file manager has instructions to back up the first files on the first computer to the EHD when the EHD is initially connected to the first computer; and wherein when the EHD is connected to a second computer, the file manager has instructions to back up the first files to the EHD via the network and the second computer.

Alternatively, the invention may comprise various other methods and apparatuses.

Other features will be in part apparent and in part pointed out hereinafter.

### BRIEF DESCRIPTION OF THE DRAWINGS

FIG. 1 is a block diagram illustrating a back-up system wherein copies of files stored on an originating computer are encrypted and transferred to a destination computer.

FIG. 1A is a screen shot illustrating an exemplary validation form of the invention.

FIG. 1B is a screen shot illustrating an exemplary destination identification form of the invention.

FIG. 2 is a block diagram illustrating the components of an application that allows files stored on the originating computer to be retrieved, encrypted and transferred to the destination computer.

FIG. 2A is a screen shot illustrating an exemplary file designation form of the invention.

FIGS. 2B and 2C are screen shots illustrating an exemplary storage schedule forms of the invention.

FIG. 2D is a screen shot illustrating an exemplary form for defining an encryption pass phrase.

FIG. 2E is a screen shot illustrating an exemplary form for electing to retrieve a group of files or to retrieve individual files from storage.

FIG. 3 is a block diagram illustrating the components of an application that allows encrypted copies of files stored on the destination computer to be transferred to an originating computer and decrypted.

FIG. 3A is a screen shot illustrating an exemplary destination storage amount form of the invention.

FIG. 3B is a screen shot illustrating an exemplary authentication form of the invention.

FIG. 4 is an exemplary flow diagram illustrating a method for transferring copies of files from an originating computer to a destination computer according to one preferred embodiment of the invention.

FIG. 5 is an exemplary flow diagram illustrating a method for retrieving back-up copies from a destination computer according to one preferred embodiment of the invention.

FIG. 6 is a block diagram illustrating a back-up system wherein initial copies of files stored on an originating computer are encrypted and stored on a portable medium for manual transfer to a destination computer.

FIG. 7 is an exemplary flow chart illustrating a method for transferring back-up copies of one or more files from the originating computer to a portable storage medium for delivery to the destination user.

FIG. 8 is an exemplary flow chart illustrates a method for verifying that the originating user desires to transfer back-up copies of one or more files from the originating computer to a portable storage medium for delivery to the destination user.

FIG. 9A is a block diagram illustrating a first computer and an external hard drive (EHD) being configured from a server so that back up copies of first files on the first computer are stored on the EHD.

FIG. 9B is a block diagram illustrating a first computer being configured from an external hard drive (EHD) and optionally from a server so that back up copies of first files on the first computer are stored on the EHD.

FIG. 10 is a block diagram illustrating a second computer being configured from an external hard drive (EHD) and optionally from a server so that back up copies of second files on the second computer are stored on the EHD.

FIG. 11 is a block diagram illustrating first and second computers configured to back up their files on an EHD connected to a remote computer.

Corresponding reference characters indicate corresponding parts throughout the drawings.

### DETAILED DESCRIPTION OF THE INVENTION

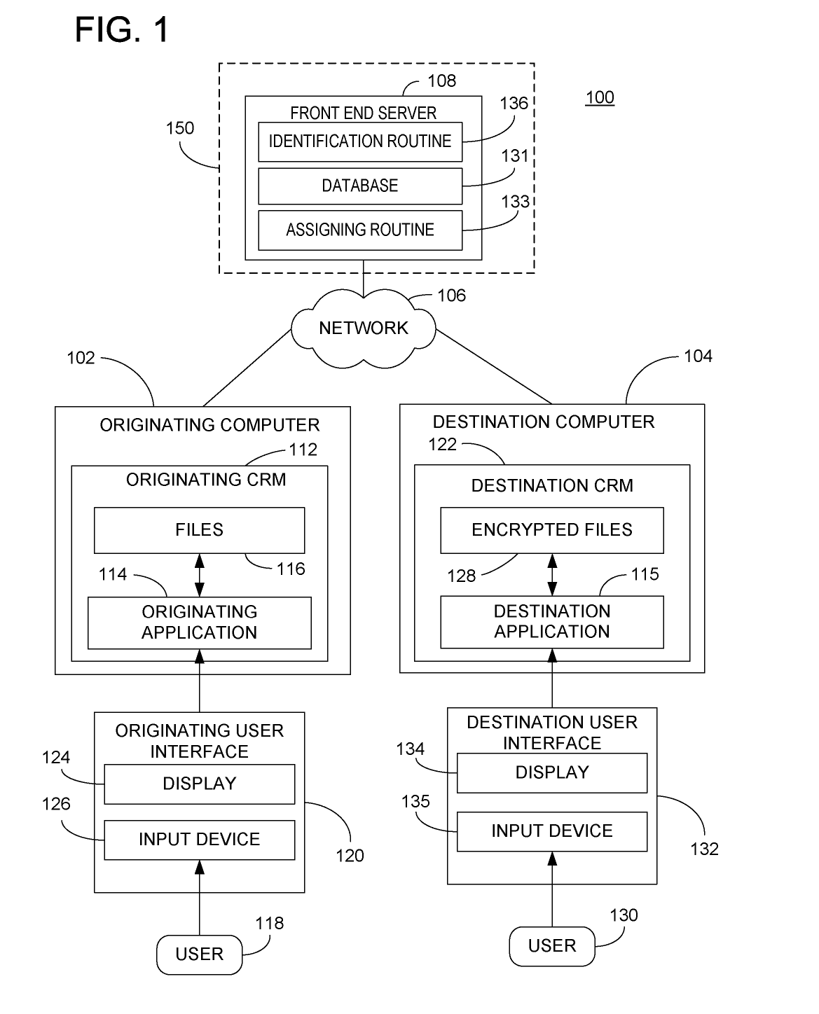

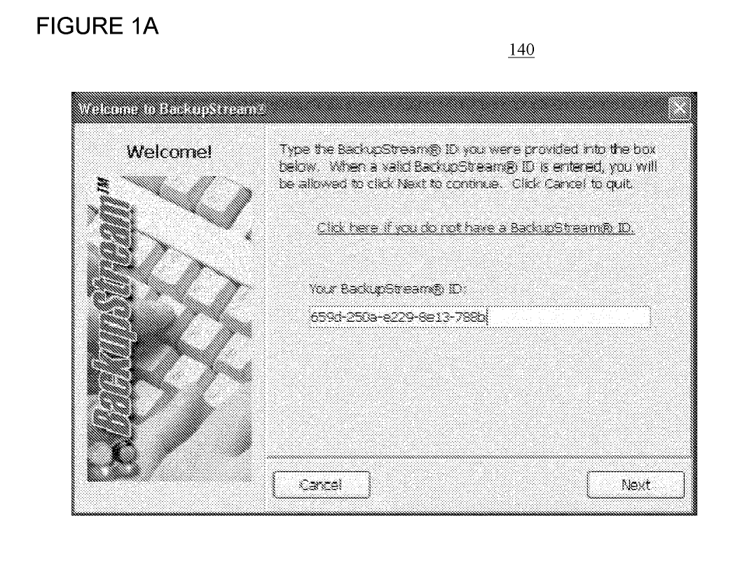

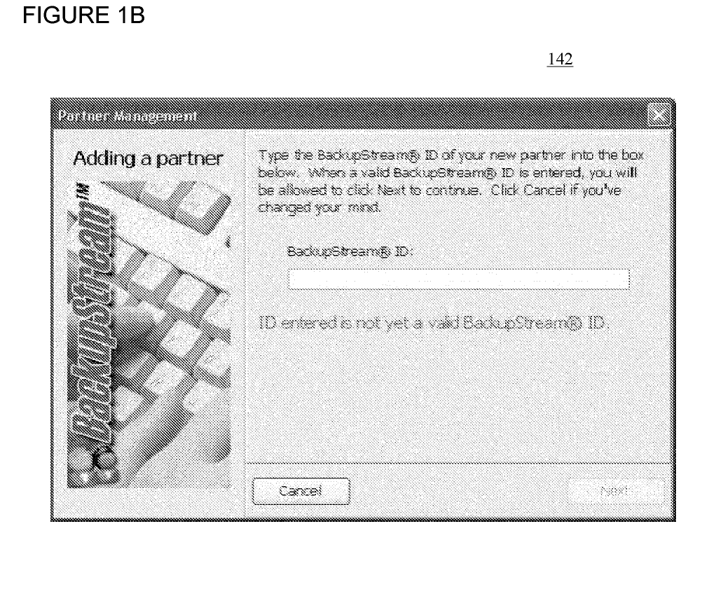

Referring first to FIG. 1, an exemplary block diagram illustrates a back-up system 100 for transferring copies of files from an originating computer 102 to a destination computer 104. The originating computer 102 and destination computer 104 are coupled to a data communication network 106 such as the Internet (or the World Wide Web) to allow the originating computer 102 and destination computer 104 to communicate. In the example of FIG. 1, the invention employs an application that allows a user to designate files from the originating computer for which back-up copies will be transferred to the destination computer 104, and allows the originating computer 102 to retrieve back-up files from the destination computer 104. The application of the invention also allows the originating computer to receive back-up copies of files from the destination computer 104.

The originating computer 102 is linked to an originating computer-readable medium (CRM) 112. The originating CRM 112 contains an originating application 114, and stores one or more files 116. An originating user 118, using an originating user-interface (UI) 120 linked to the originating computer 102 designates one or more files 116 stored on the originating CRM 112 for which to transfer copies to a destination CRM 122 for storage. For example, the UI 120 may include a display 124 such as a computer monitor for viewing forms requesting input from the user, and an input device 126 such as a keyboard or a pointing device (e.g., a mouse, trackball, pen, or touch pad) for entering data into such an input form.

The destination computer 104 is linked to a destination CRM 122. The destination CRM 122 contains a destination application 115, and may store one or more encrypted files 128 previously transferred from the originating CRM 112. A destination user 130 using a destination UI 132 linked to the destination computer 104 allocates the originating user 118 an amount of storage space on the destination CRM 122. For example, after the destination user 130 has agreed to become a storage partner with the originating user 118, the destination user 130 use an input device 135 to enter data into an input form being displayed on the destination display 134 to allocate the originating user 118 10 megabytes of storage space on the destination CRM. Alternatively, the destination user 130 may allocate the originating user 118 all of the storage space on the destination CRM 122 (e.g., an entire hard drive). Notably, the originating application 114 and the destination application 115 are the same application. In other words, the application of the invention possesses dual functionality to allow the same application to be used on both the originating computer 102 and the destination computer 104.

In one embodiment, a front end server (server) 108, also referred to as “web server” or “network server,” is also coupled to the communication network 106, and allows communication between the server 108 and the originating computer 102, and between the server 108 and the destination computer 104. In this example, the originating computer 102 and the destination computer 104 download the originating application 114 and destination application 115, respectively, from the server 108 using the File Transfer Protocol (FTP). However, the application of the invention can also be obtained through any other commercial transaction. The originating computer 102 and the destination computer 104 can also retrieve identification data from the server 108 using the Hypertext Transfer Protocol (HTTP). As known to those skilled in the art, FTP is a protocol commonly used on the Internet to exchange copying and/or transferring files to and from remote computer systems, and HTTP is a protocol commonly used on the Internet to exchange information. As described in more detail below, identification data includes an application identification code and an Internet protocol address associated with a particular computer.

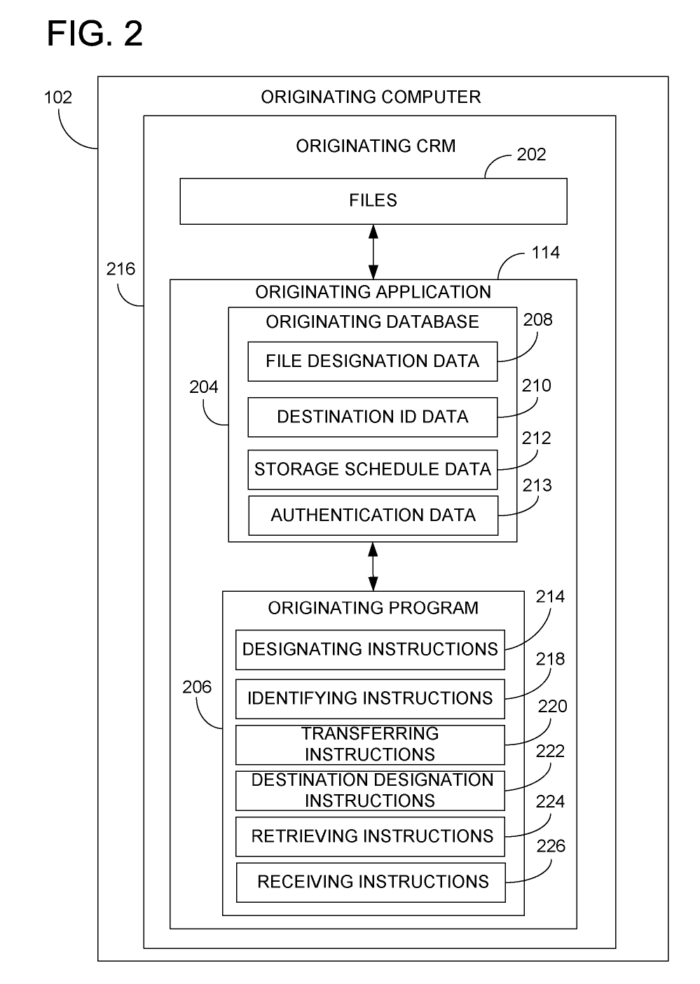

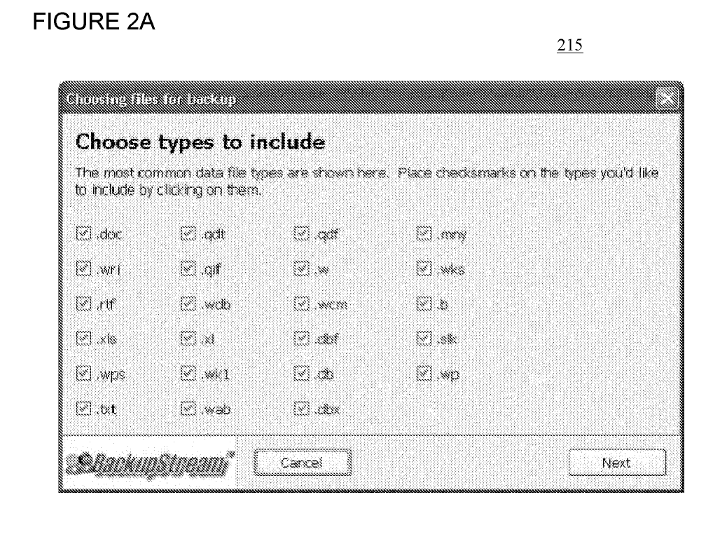

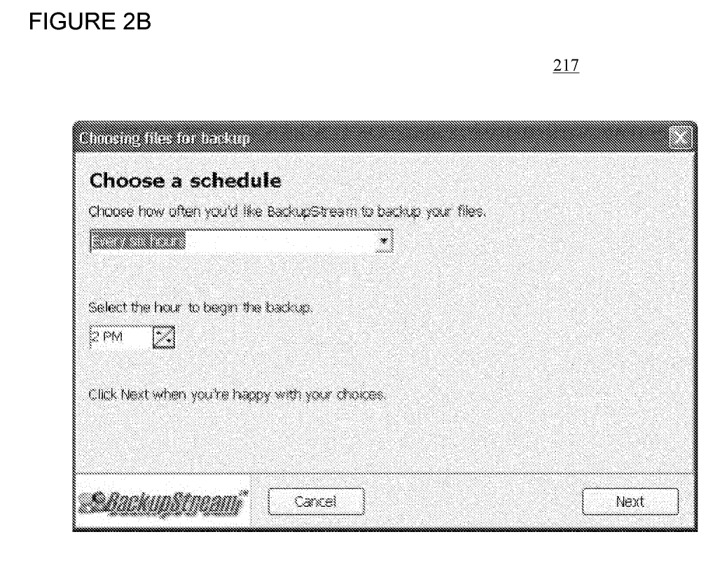

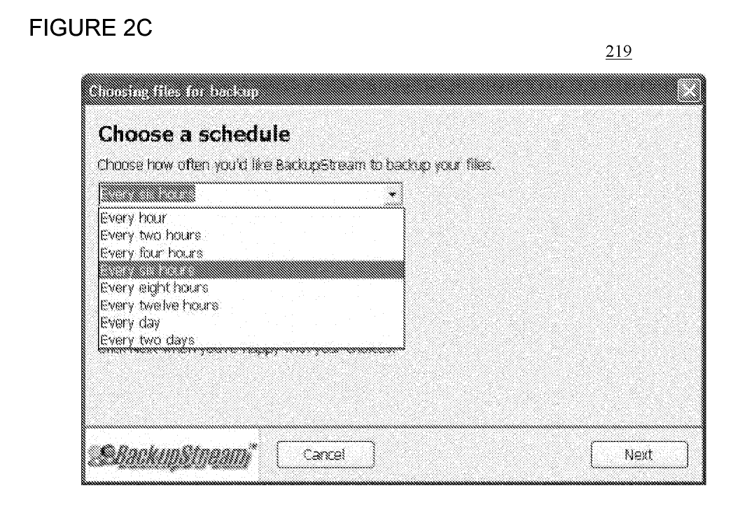

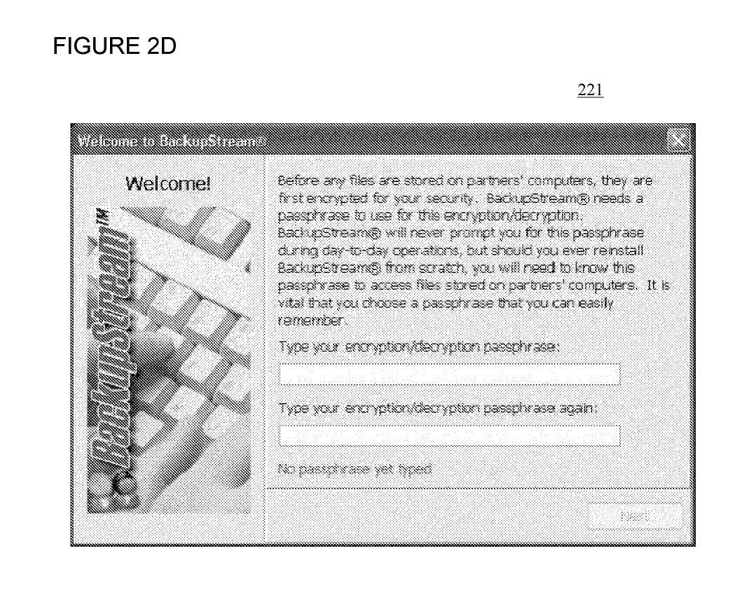

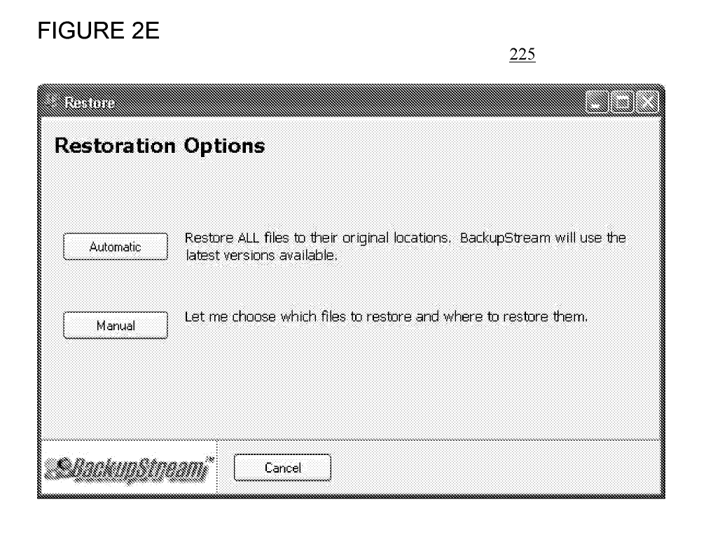

The server 108 is coupled to a back-up database 131 that store identification data. For example, the back-up database 131 contains an Internet Protocol (IP) address and unique application identification code (ID) for each of the originating and destination computers. As known to those skilled in the art, the IP address uniquely identifies a computer when it is connected to the Internet via an Internet Service Provider (ISP). In one embodiment, after a user loads the application of the invention for use on a particular computer by downloading or other copying, the server 108 emails the user an application ID. The user then submits the application ID back to the server 108 via a validation form 140 such as illustrated in FIG. 1A to validate the application, and to associate the submitted application ID with the particular computer to which the application was downloaded. During this initial communication session, or any subsequent communication session, between computer and the server 108, the server 108 records and stores the IP address of the computer submitting the application ID in the back-up database 131. The server 108 also executes an assigning routine 133 to assign the submitted application ID to the computer from which the application ID was submitted. Thereafter, the application ID and corresponding IP address associated with that particular computer are maintained in the server database 131. As a result, the server 108 can be used to obtain an IP address associated with the destination computer 104. For example, the originating user 118 submits the destination ID to the server 108 via an identification form 142 such as shown in FIG. 1B to identify the IP address of the destination computer 104. The server 108 executes an identification program 136 to verify that the submitted application ID is valid, and then queries the server database 131 to identify the last known IP address associated with destination computer 104. As described below in FIG. 2, the destination ID and corresponding IP address are also maintained in the originating computer 102.

Moreover, the server 108 obtains the IP address of the originating computer 102 when the originating user is requesting the IP address of an existing partner. As known to those skilled in the art, ISP providers frequently change the IP address assigned to a particular computer. As a result, the originating computer 102 may not be able to establish a connection with the destination computer 104. To verify that the originating computer 102 has the correct IP address stored for the destination computer 104, the originating user 118 contacts the server 108 in order to obtain the last known IP address of the existing partner's computer. During this subsequent communications session between the originating computer 102 and the server 108, the server 108 again obtains and stores the IP address of the originating computer 102. Likewise, if the destination user 130 has sent a similar IP request to the server 108 for any computer sharing space with destination computer 104, the server 108 will also have the IP address of the destination computer at the time the IP request was made. Thus, the originating computer 102 can obtain the latest known IP address of the destination computer 104 from the server 108, and can attempt to establish a communication session with the destination computer 104 via the latest known IP address.

Notably, the server 108 is optional, as indicated by reference character 150, and is not necessary component of the back-up system 100 for transferring files between the origination and destination computers. In other words, if the originating computer 102 has the IP address of the destination computer stored in memory (e.g., originating database 204), the originating computer 102 can communicate directly with the destination computer, and there is no need to communicate with the server 108.

Referring now to FIG. 2, a block diagram illustrates the components of a originating application 114 that allows files 202 (e.g., files 116) stored on the originating computer 102 to be designated, encrypted, and transferred to the destination computer 104 according to one preferred embodiment of the invention.

In this embodiment, the origination application 114 uses an originating database 204 and an originating program 206 to transfer copies of files 202 from the originating computer 102 to the destination computer 104. The originating database 204 stores file designation data 208, destination identification (ID) data 210, and storage schedule data 212, and authentication data 213. The originating program 206 includes originating designating instructions 214 for designating files to back-up (i.e., copy to destination computer), identifying instructions 218 for identifying the destination computer, and transferring instructions 220 for transferring the encrypted files 202 to the destination computer.

Originating designating instructions 214 include instructions for displaying a file transfer designation form 215 such as shown in FIG. 2A on the display 124. In this case, the file designation transfer form 215 allows the originating user 118 to select one or more file extensions (e.g., .txt, .doc, etc.). This allows the user to designate all files from the originating CRM 216 (e.g. CRM 112) having the one or more selected file extensions for copying to the destination computer 104. In alternate embodiment (not shown), the user selects files from a list files (e.g., file list box showing files on computer), or the user uses a keyboard to type a specific file name. The files 202 designated by the user are stored as file designation data 208 in the originating database 204.

Originating designation instructions 214 also include instructions for displaying a storage schedule form 217, 219 such as shown in FIGS. 2B and 2C, respectively, to the user on the display 124. The storage schedule form 217 allows the user to designate storage schedule data 212. The storage schedule data 212 identifies one or more back-up times for transferring copies of designated files from the originating CRM 216 to the destination computer. For example, the originating user 118 uses the originating UI 120 to enter a specific time(s) of day, or time interval into the storage schedule form 217 to define a personal back-up schedule for one or more files designated for back-up on a particular destination computer 104. Importantly, it is not necessary to communicate to the partner the content, the subject matter, or any information about the files.

Identifying instructions 218 include instructions for displaying the destination identification form 142 (see FIG. 1B). The destination identification form 142 allows the user to identify the particular destination computer 104 to which to transfer copies the designated files. In this case, a “partner” (i.e., user of a particular destination computer) is identified and added to the originating database 204 by entering the unique application ID (i.e., destination ID) that corresponds to the particular originating application 114 stored on the destination computer 104. The originating user 118 obtains the application ID corresponding to the particular destination computer 104 (i.e., destination ID) by communicating (e.g., verbal communication, email, etc.) with the partner (i.e., destination user). As described above, the destination ID is a unique identification code assigned to the destination computer 104 when the originating application 114 is purchased or downloaded from the server 108. The destination ID provides access to the corresponding IP address of the destination computer 104 through a lookup function executed against the back-up database 131 maintained by the server (i.e., server database) or a third party.

Originating transferring instructions 220 include instructions for initiating a communication session with the destination computer 104 in response to input received from a user 118 to transfer copies of the designated files to the destination computer 104. Originating transferring instructions 220 also include instructions for encrypting the copies of the designating files prior to transferring copies to the destination computer 104. In one embodiment, the originating application 114 utilizes a Triple Data Encryption Standard (3DES) to secure (i.e., encrypt) the contents of the files prior to transfer. Before encryption instructions can be executed, the user must first supply a pass phrase via an encryption validation form 221 (see FIG. 2D) that is then cryptographically hashed and stored in the user's registry. Thereafter, the hashed pass phrase is used to encrypt and decrypt files stored on partners' computers. If the pass phrase is lost and cannot be remembered, the files stored remotely cannot be decrypted.

After the files have been encrypted, the transfer instructions 200 execute and read destination ID data 210 in the originating database 204 to identify the destination computer 104, and then transfers the encrypted copies of the designated files to the identified destination computer 104. Once stored on the destination computer 104, the encrypted files 128 are meaningless to the partner. Even the file names are “hash codes” that are only meaningful to originating computer. In other words, the partner cannot discern the content or names of the files that have been stored on the destination computer by the originating user. Although encrypting the files is not necessary, if encryption is not used, files stored on a given partner's computer may possibly be viewed with a hex editor or other utility.

Originating transferring instructions 220 also include instructions for automatically initiating a communication session with the destination computer 104 in response to storage schedule data. For example, after the originating user 118 assigns a schedule to a particular destination computer's (i.e., partner's) configuration, the originating computer 102 initiates a communication session with the destination computer 104 to transfer encrypted copies of the designated files. Thereafter, back up can occur automatically at the back-up time(s) specified in the storage schedule data. In one embodiment, automatic back-up only occurs on files that have been changed. Importantly, automatic back-up allows the transfer of encrypted copies of files 202 from the originating computer 102 to the destination computer 104 to take place without the users of computers 102, 104 being aware that the transfer is occurring.

The originating program 206 also includes destination-designating instructions 222 for designating files to retrieve from the destination computer 102, and retrieving instructions 224 for retrieving the designated files from the destination computer 104. Destination designating instructions 222 include instructions for displaying a file retrieval form 225 (see FIG. 2E) to allow the user to retrieve a group of files or individual files. File retrieval designation forms (not shown) are similar to file transfer designation forms. More specifically, the user can designate a group of files (e.g., files having the same file type extension) for retrieval (e.g., FIG. 2A), or the user can particular files by file name. The files entered or selected by the user 118 are then stored as destination file designation data 226 in the originating database 204.

Retrieving instructions 224 use the previously identified IP address associated with the particular application ID of the destination computer 104 to initiate a communication session between the originating computer 102 and the destination computer 104 to retrieve the designated files from the destination computer. As described above in reference to FIG. 1, if the IP address of the destination computer has changed, the originating application 114 can contact the server 108 and submit the previously obtained destination ID of the destination computer 104 to query the server's database 131 for the latest IP address of the destination computer 104. The server 108 not only delivers the last known IP address of the desired application ID, but also stores the IP address of the computer submitting the application ID. In this way, the server 108 maintains the latest IP address for that particular computer in the server database 131. In one preferred embodiment, the retrieving instructions 224 further include instructions for decrypting retrieved encrypted files. The originating application 114 can also utilize the Triple Data Encryption Standard (3DES) to decrypt the contents of the encrypted files.

Receiving instructions 226 include instructions for initiating a communication session with the destination computer 104 in response to a transfer request received from the destination computer 104 to transfer copies of the designated files on the destination computer 104 to the originating computer.

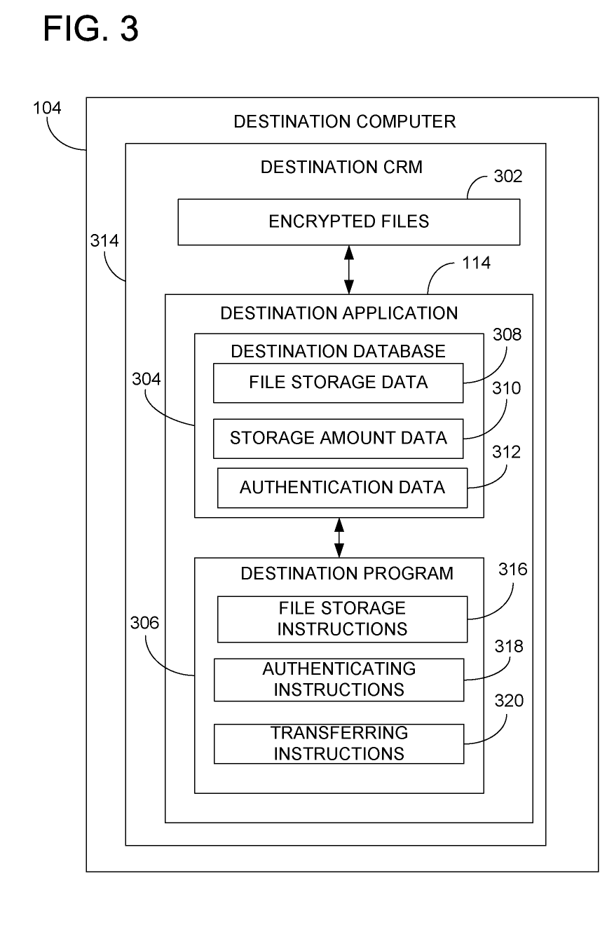

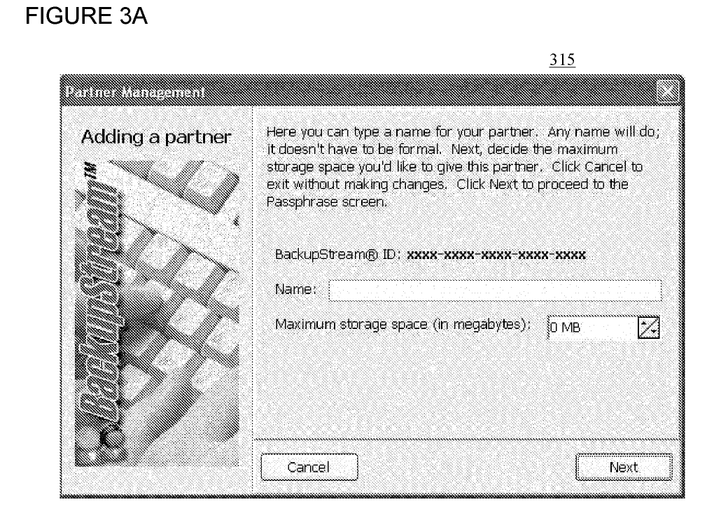

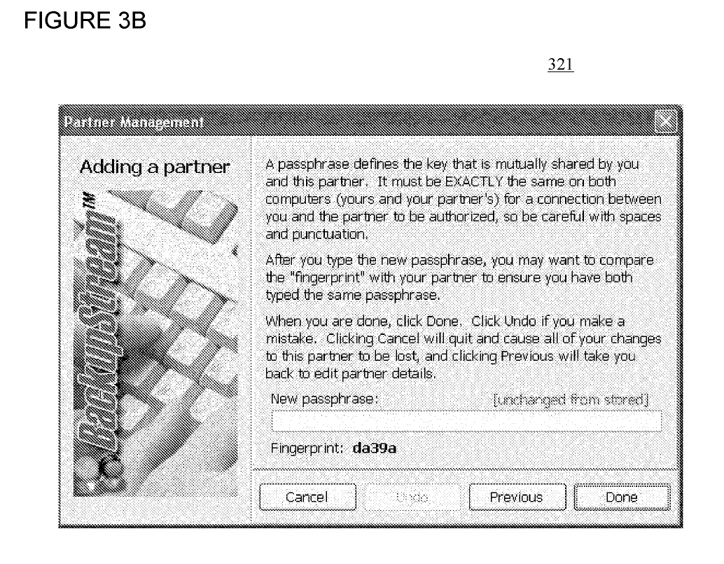

Referring now to FIG. 3, a block diagram illustrates components of a destination application 115 allowing encrypted copies of files 302 received from an originating computer 102 to be stored on the destination computer 104.

In this embodiment, the destination application 115 uses a destination database 304, and a destination program 306 to store of back-up copies of files from the originating computer 102 onto the destination computer 104. The destination database 304 includes file storage data 308, storage amount data 310, and authentication data 312. File storage data 308 identifies encrypted files and/or post-transfer data regarding files received from the originating computer 102 and stored on the destination CRM 314 (e.g., CRM 122). For instance, post-transfer data includes the total amount of disk space currently being used to store back-up copies of files from the originating computer. The storage amount data 310 identifies an amount of storage space (i.e., disk space) on the destination CRM 314 that the destination user 130 has authorized for use by the originating user 118. The destination user 130 can allocate the originating user 118 a few megabytes or an entire hard drive of storage space on the destination computer 104. For example, the destination user 130 uses a storage amount form 315 such as shown in FIG. 3A to enter an amount of storage space that has been mutually agreed upon by both users 118, 130. The authentication data 312 includes authentication information used to verify that the originating user 118 is authorized to store files on the destination computer 104, and/or retrieve files from the destination computer 104.

The destination program 306 includes file storage instructions 316, authentication instructions 318, and transferring instructions. The destination program 306 can be executed by the destination user 130, or by the originating program 206. For instance, the destination user 130 executes the storage instructions 316 to define and authorize a maximum amount of storage space on the destination CRM 314 for storing files from the originating computer 102. In another embodiment, the storage instructions 316 include instructions for determining whether sufficient storage space is available on the destination CRM 314 to store copies of files from the originating computer 102. For example, upon execution, the storage instructions retrieve file storage data 308 identifying the amount of disk space currently being used to store copies of files from the originating computer 102 (e.g., post transfer data). The storage instructions 316 then compare the storage amount data 310 defined by the destination user 130 to the file storage data 308 to determine if storage space is available. If sufficient storage space is available, the one or more files are stored on the destination CRM 314. If sufficient storage space is not available, the storage instructions 316 display a message on the originating display that informs the originating user that there is insufficient storage space.

The originating user 118 executes the destination program 306 by executing the retrieval instructions 224. As discussed above in reference to FIG. 2, when the retrieving instructions 224 are executed, a communication link is established between the destination and originating computers to selectively retrieve one or more encrypted files. After the communication link is established, the retrieving instructions 224 read the destination file storage data 226 from the originating database 206, and retrieve one or more encrypted files from the destination CRM 314. Thereafter, the destination transferring instructions 320 transfers the designated encrypted files to the originating computer 102.

Authentication instructions 318 include instructions for determining whether the originating user 118 is authorized to store files on the destination CRM 314, and/or is authorized to retrieve files from the destination CRM 314. For example, when the originating computer 102 contacts the destination computer 104 for a communication session, the destination computer 104 executes authentication instructions 318. The authentication instructions 318 include instructions for retrieving previously defined authentication data such as a password. For example, after the originating user 118 and destination user 130 have agreed to become storage partners, they each define a mutually agreed pass phrase to store as authentication data in the originating database 204 and destination database 304, respectively. In one embodiment, an authentication form 321 such as shown in FIG. 3B is used by both users 118, 130 to enter the mutually agreed upon password. The authentication instructions 318 also include instructions for comparing the authentication data 213 stored in the originating database 204 to the authentication data 314 stored in the destination database 304. If the authentication data 213 stored in the originating database matches the authentication data 314 stored in the destination database 304, the originating application 114 is allowed to access the destination CRM 314 for file storage and/or file retrieval. By comparing the predefined authentication data, the user 118 is not required to enter a password during future back-up session between the originating computer 102 and the destination computer 104.

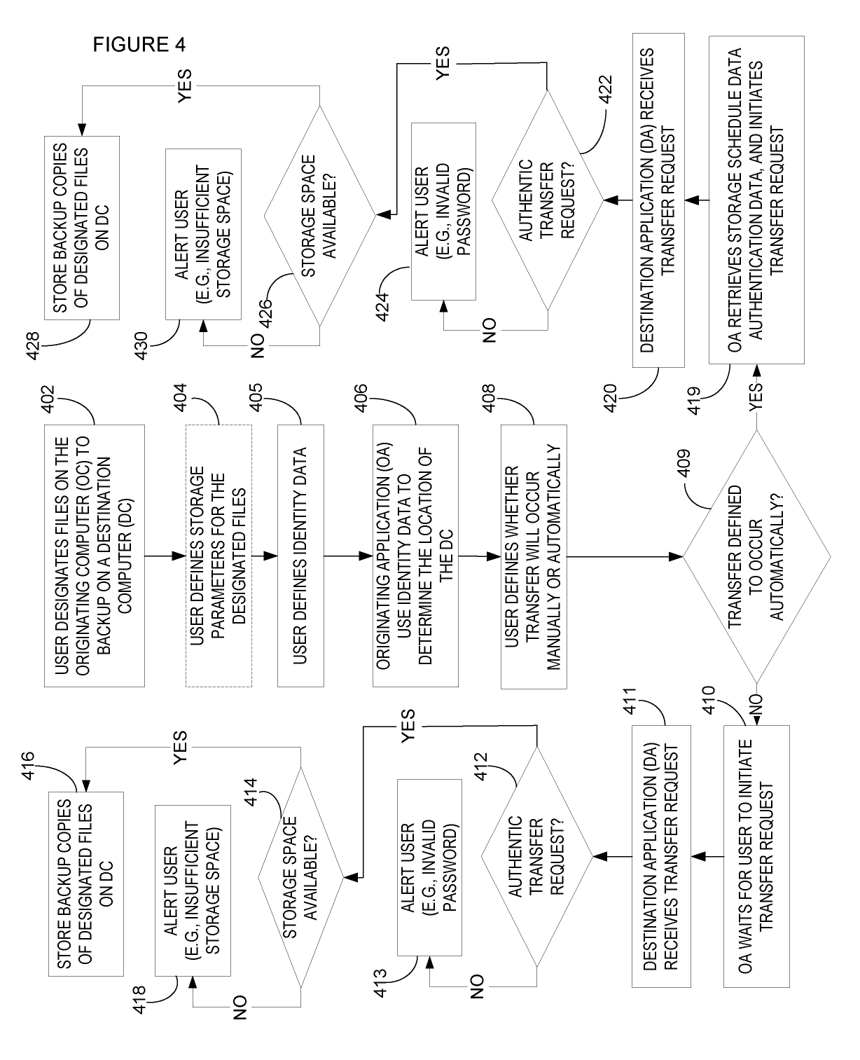

Referring now to FIG. 4, a flow chart illustrates a method for transferring back-up copies of one or more files from the originating computer 102 to the destination computer 104. At 402, the user uses UI 118 to designate files from the originating computer 102 for which to transfer copies to the destination computer 104. At an optional step 404, the user uses the UI 118 to define file parameter data for the designated files. For instance, the user may use the UI 118 to define back up schedule data. Back up schedule data includes specific times and/or intervals for transferring the designated files. As described above, authentication data may include a password, or pass phrase, that has been mutually agreed upon between partners. At 405, the user uses UI 118 to define identification data to identify the destination computer. Identification data includes a unique application ID (i.e., destination ID) that corresponds to the particular destination application 115 stored on the destination computer. At 406, the originating application 114 uses the identification data to determine the location of the destination computer 104. As described above, the destination ID provides access to the corresponding IP address of the destination computer 104 through a lookup function executed against the database 131 maintained by the server. At 408, the user uses the UI to define whether the transfer of back-up copies to the destination computer initiates manually or automatically. The originating application 114 determines whether the user has defined the transfer of back-up copies to occur manually or automatically at 409.

If the application determines the transfer of back-up copies is defined to occur manually at 409, the originating application 114 waits for the user to initiate a transfer request at 410. For example, the user uses a mouse to click a transfer button on a form (not shown) being displayed to the user via the display, and the originating computer request a communication session with destination computer having the identified IP address. The destination application 115 receives the transfer request at 411. At 412, the destination application 115 authenticates the transfer request to determine whether the originating computer is authorized to transfer files to the destination computer 104 for storage. As an example, authentication may involve comparing authentication data received from the originating computer along with the transfer request to authentication data stored on the destination computer 104. As described above in reference to FIG. 2, authentication data includes a password previously defined by users 118, 130 and stored in the originating database 204 and destination database 304, respectively. If authentication data from the originating computer 102 does not match the authentication data stored on the destination computer 104, the originating computer 102 is not authenticated at 412, and the destination application 115 alerts the user that the password is invalid at 413. If the entered password matches the authentication data stored on the destination computer 104, the originating user is authenticated at 412. In one embodiment, after the destination computer 104 receives a transfer request from the originating computer 102, the destination computer 104 generates a random number and sends it to the originating computer 104. The originating computer 102 performs a one-way hash function on the random number and the locally-stored password and sends the result back. The destination computer then computes the same function and compares the results. In this way, the originating computer can be authenticated without revealing the password. As known to those skilled in the art, a one way hash function is used to generate a cryptographically-secure message, and is a function that is easy to compute in the forward direction, but computationally infeasible to invert. After the originating computer is authenticated, the destination computer determines whether sufficient storage space is available for storing back-up copies at 414. For example, the destination compares the amount disk space required for storing the back-up copies to storage amount data defining an amount of disk space the destination user has allocated to the particular originating user. If sufficient storage space is determined available at 414, the back-up copies are stored on the destination computer at 416. If sufficient storage space is determined not available at 414, the originating user is alerted that there is insufficient storage space at 418.

If the application determines the transfer of back-up copies is defined to occur automatically at 409, the originating computer retrieves storage schedule data and authentication data, and automatically initiates a transfer request for transferring back-up copies of the designated files to the identified destination computer at the times defined by the storage schedule data at 419. The destination application 115 receives the transfer request at 420. At 422, the destination application 115 authenticates the transfer request to determine whether the originating computer 102 is authorized to transfer files to the destination computer for storage. Again, authentication may involve comparing authentication data stored on the originating computer 102 to authentication data stored on the destination computer 104. If the authentication data stored on the originating computer 102 does not match the authentication data stored on the destination computer 104, the originating computer is not authenticated at 422, and the destination application 115 alerts the user that the password is invalid at 424. If the authentication data stored on the originating computer 102 matches the authentication data stored on destination computer 104, the originating computer is authenticated at 420, and the destination application 115 determines whether sufficient storage space for storing back-up copies is available at 426. If sufficient storage space is available, the back-up copies are encrypted and stored on the destination computer at 428. If sufficient storage space is not available, the originating user is alerted that there is insufficient storage space at 430.

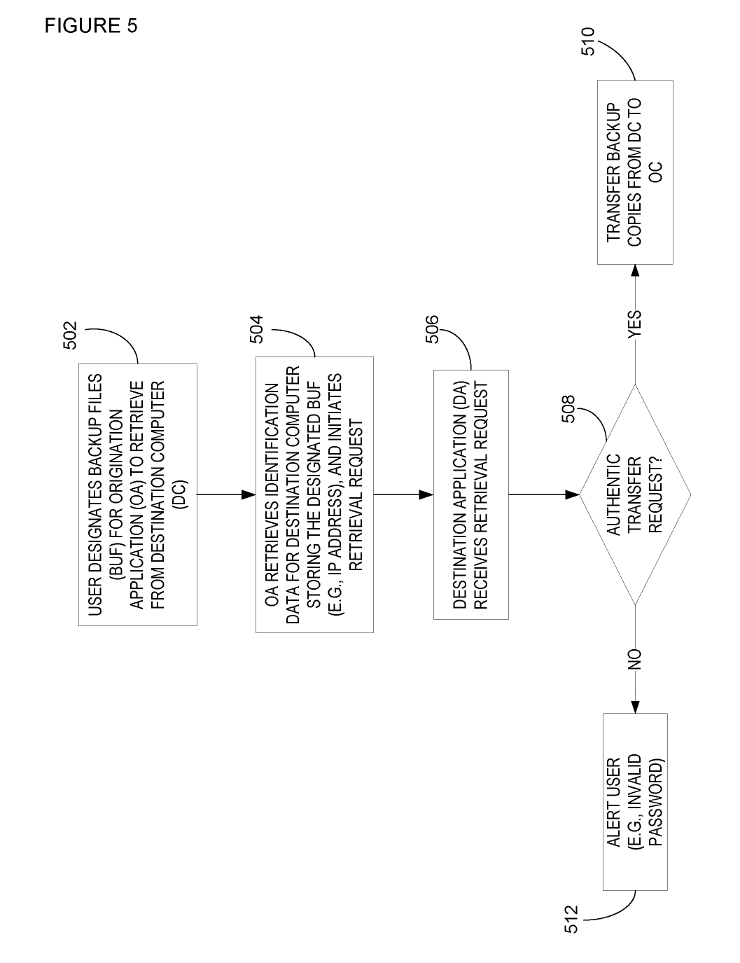

Referring now to FIG. 5, a flow chart illustrates a method for transferring back-up copies of one or more files from the destination computer 104 to the originating computer 102. At 502, the user uses UI 124 to designate files (e.g., back-up copies) to retrieve from the destination computer 104. At 504, the originating application 114 retrieves identification data stored in the originating database 108 to determine the location (i.e., IP address) of the destination computer 104, and submits a retrieval request to the identified destination computer 104 via the communication network. The destination application 115 receives the retrieval request for the designated files at 506. At 508, the destination application 115 authenticates the retrieval request. For example, authentication data stored on destination computer is compared to authentication data submitted from the originating computer along with the retrieval request. If the authentication data received from the originating computer 102 is determined to match authentication data stored on destination computer 104, the user is authenticated at 508, and the destination application 115 transfers the requested files to the originating computer for decryption at 510. If the authentication data received from the originating computer 102 is determined not to match authentication data stored on destination computer 104 the user is not authenticated at 508, and the user is alerted of that the authentication process has failed at 512.

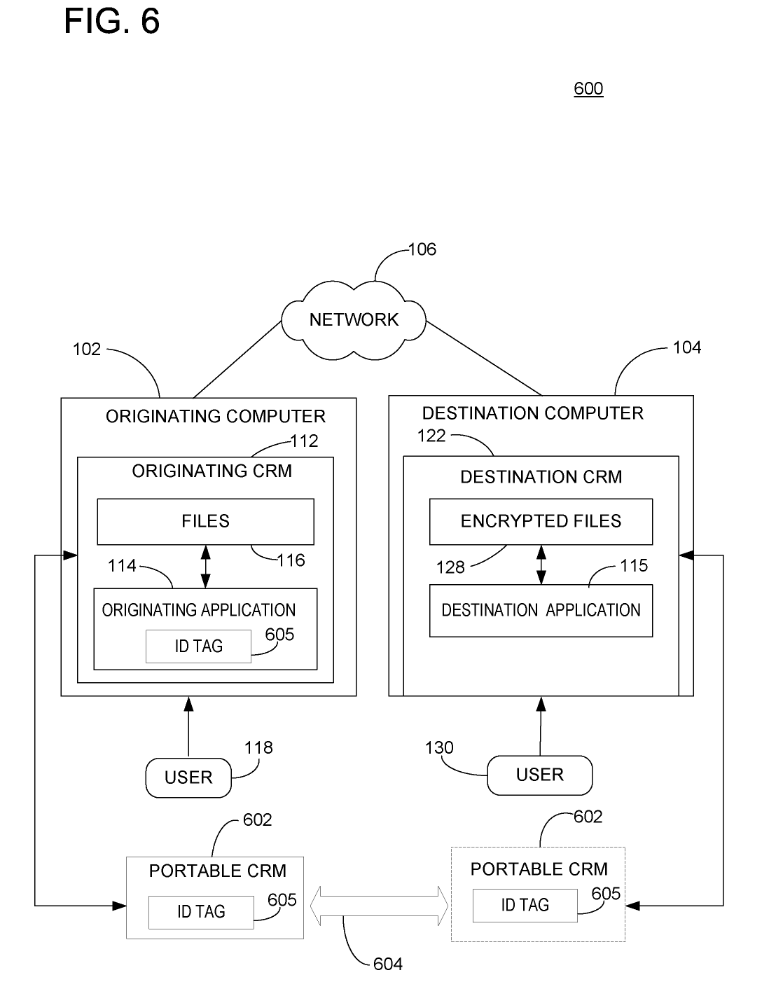

Referring now to FIG. 6, a block diagram illustrates a back-up system 600 wherein copies of files stored on an originating computer are encrypted and stored on a portable medium for manual transfer to a destination computer.

As known to those skilled in the art, regardless of the connection type (e.g., broadband, dial-up, etc.) there are limits to the rate at which data can be transferred over communication networks such as the Internet. As a result, when the originating user 118 transfers large amounts of data (e.g., file data of 1 Gigabyte (GB) or more) to the destination computer 104 for back-upback-up, the transfer may require several hours. Although the back-upback-up stream system 100 allows data transfer to occur without the knowledge of destination user 130, due to the amount of time required for transferring large amounts of data, such transfers are more likely to be interrupted, for example, by a network time-out, or power interruption to either the originating computer 102 or the destination computer 104. In this embodiment, rather than transferring designated files directly to the destination computer 104 via the network 106, the originating user 118 initially transfers the designated files to a portable computer readable medium (portable medium) 602 such as zip drive, tape, Compact Disc (CD) or Digital Versatile Disk (DVD). For example, if the user desires to back-up files having a total file size that exceed 1 GB, the user may decide to transfer the files via a portable medium due to a previous experience (e.g., network time out) while backing up files of similar size. In such a case, prior to transferring copies of the designated files to the portable medium 602, the originating application 114 executes originating transferring instructions 220, as described above in reference to FIG. 2, to encrypt copies of the designating files. Thereafter, the originating user 118 delivers the portable medium 602 having the encrypted file data to the storage partner (i.e., destination user 130), and the destination user 130 uploads or transfers the encrypted files from the portable medium 602 to the destination CRM 112. The delivery, as indicated by reference character 604, takes place, for example, via mail, courier service, or some other manual means of physically transporting the medium 602 from first a geographical location to a second geographical location.

The transfer instructions 200 also transfer authentication data from the originating computer 102 to the portable medium 602. Again, as described above in reference to FIG. 3, the authentication data 312 includes authentication information used to verify that the originating user 118 is authorized to store files on the destination computer 104, and/or retrieve files from the destination computer 104.

After the destination user 130 receives the portable medium 602, as indicated by phantom lines, the user 130 initiates transfer of the files stored on the portable medium 602 to the destination computer 130. As shown in FIG. 3, the destination application 114 includes file storage instructions 316. In this embodiment, the file storage instructions 316 include instructions for determining whether sufficient storage space is available on the destination CRM 314 to store copies of files stored on portable medium 602. The storage instructions 316 then compare the storage amount data 310 defined by the destination user 130 to the file storage data 308 to determine if storage space is available. If sufficient storage space is available, the one or more files are stored on the destination CRM 314. If sufficient storage space is not available, the storage instructions 316 display a message on the destination computer display to inform the destination user 130 that there is insufficient storage space. In response to such a message, the destination user 130 can allocate more storage space, as described above in reference to FIG. 3, or discontinue the transfer process and notify the originating user 118 that his or her storage capacity has been reached.

As described above in reference to FIG. 3, the destination application includes authentication instructions 318 for comparing the authentication data 213 stored in the originating database 204 to the authentication data 312 stored in the destination database 304. In this embodiment, authentication instructions 318 compare authentication data 312 transferred to the portable medium 602 from the originating computer 102 to the authentication data stored in the destination database 304. If the authentication data 213 stored in the originating database 204 matches the authentication data 314 stored in the destination database 304, the originating user 118 is authenticated to access the destination CRM 314 for file storage. By comparing the predefined authentication data, imposters or non-storage partners are prevented from tricking an unsuspecting destination user 130 into transferring unauthorized data onto the destination computer 104. Notably, when authentication data such as the mutually agreed upon passphrase is transferred to the portable computer readable medium, the method of delivery should be secured and/or trusted. If the method of delivery is not secure, the portable medium 602 could be lost or stolen, and thereby potentially recoverable by a malicious user.

In another preferred embodiment, after the originating user 118 elects to store data on a portable computer readable medium 602, the originating application 114 generates a unique identification tag (ID tag) 605. The ID tag 605 is used to identify a particular file or group of files being transferred to the portable computer readable medium at a particular time. In this embodiment, the ID tag 605 includes a randomly generated set of numbers and/or characters (e.g., key), and volume identification data. For example, a randomly generated alphanumeric value “AA0121” corresponds to a set of files the originating user transferred to the portable computer readable medium on Monday, Mar. 2, 2004, and the alphanumeric value “AB0132” corresponds to a next set of files that the originating user transferred to the portable computer readable medium on Mar. 20, 2004. Volume identification data identifies, a particular version of file data being transferred.

The originating application 114 stores the ID tag 605 in the originating database 204 of the originating computer 102, and the transferring instructions 220 transfer the ID tag 605, to the portable computer readable medium 602 for storage. As described above, after the destination user 130 initiates transfer of the files and file data, including the ID tag 605 from the portable medium 602 to the destination computer 130, the destination application 115 executes the authentication instructions 318. In this embodiment, the authentication instructions 318 include instructions for verifying that the originating user 118 desires to back-up the one or more files identified by the ID tag 605. More specifically, the authentication instructions 318 use the previously identified IP address associated with the particular application ID of the originating computer 102 to initiate a communication session, via the communication network 106, between the originating computer 102 and the destination computer 104. As described above, the application ID is a unique identification code assigned to the originating computer 102 when the originating application 114 is purchased or downloaded from the server 10, and provides access to the corresponding IP address of the originating computer 102 through a lookup function executed against the back-up database 131 maintained by the server (i.e., server database) or a third party. The authentication instructions 318 send the ID tag 605 obtained from the portable medium 602 back to the alleged originating computer 102 via the network 106, which then sends a reply back to the destination computer 104 via the network 106 either allowing the file copy transaction to occur or not to occur. The originating application 114 is responsive to the received ID tag 605 to query the originating database 204 for that particular ID tag 605. If the ID tag 605 is found, the originating application 114 displays, for example, a dialog box (not shown) on the display of the originating computer 102 listing the one or more files associated with the ID tag 605, and presents a message to the originating user 118 such as “ARE THESE FILES AUTHORIZED FOR BACK-UP.”. For example, if the user desires to proceed with back-up, the user 118 left clicks a “Yes” button in the dialog box, and a reply is sent to the destination computer 104 that the files are authorized for back-up. If the ID tag 605 is not found, or the user 118 does not wish to proceed with back-up (e.g., left clicks a “No” button in the dialog box), the originating application 114 sends a reply back to the destination computer 102, via the network 106, that the files are not authorized for back-up. This allows the originating user 118 to verify that the proper data set is attempting to be loaded on the destination computer. Moreover, this prevents the destination user 130 from maliciously or accidentally waiting a period of time (e.g., week, month, etc.) and transferring the data again, thereby potentially overwriting back-up data stored during the interim.

In another embodiment (not shown), the key portion (i.e., randomly generated number) of the ID tag 605 is used in a symmetric key encryption process to encrypt the contents of entire disc, and destination computer initiates a communication session with the originating computer 102 to requests the tag. In turn, the originating computer could either deny it (e.g., expired) or provide it, which would then allow the disc load to proceed.

Subsequent transfer of smaller data amounts can be transferred via the communication network, such as described above in reference to FIGS. 1-5. Moreover, transferring large amounts of data manually essentially jump-starts the transfer of smaller amounts of data over the communication network 106. In other words, small increments of data can be transferred in less time. In the event the originating user 118 loses significant amounts of data, the destination user 130 (i.e., storage partner) could transfer copies of encrypted files to the portable medium 602 and deliver it the originating user 118. Notably, although the destination user 130 can transfer data to or from the portable medium 602, the partner (i.e., destination user) cannot discern the content or names of the files that have been stored on the portable medium 602 by the originating user.

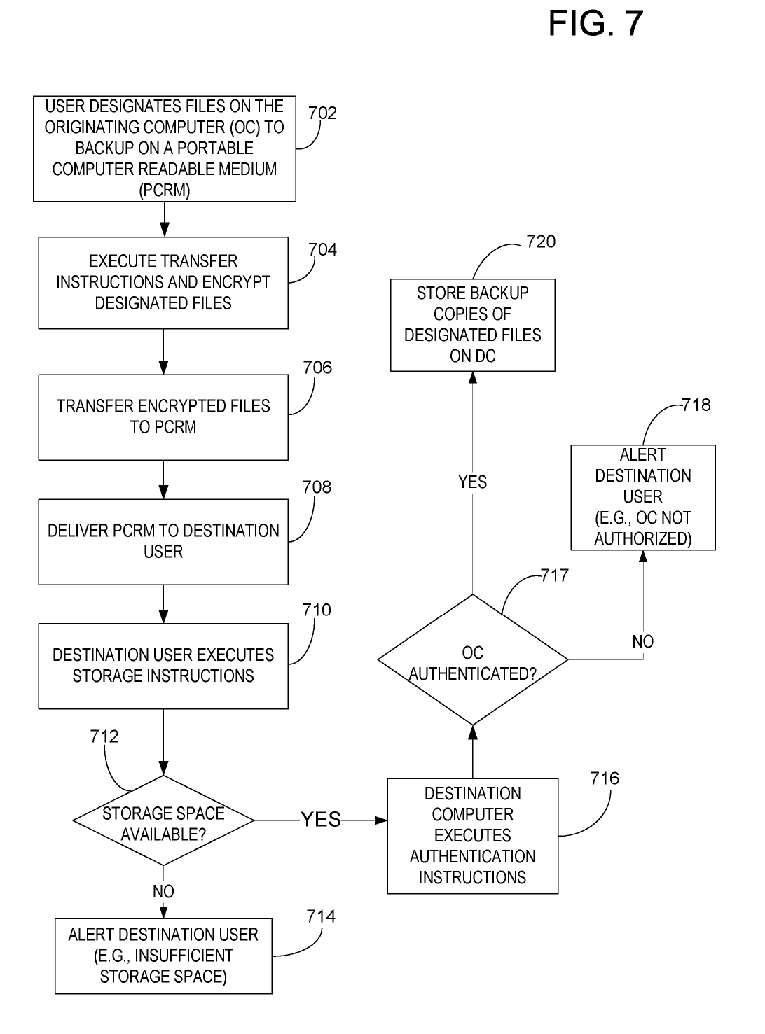

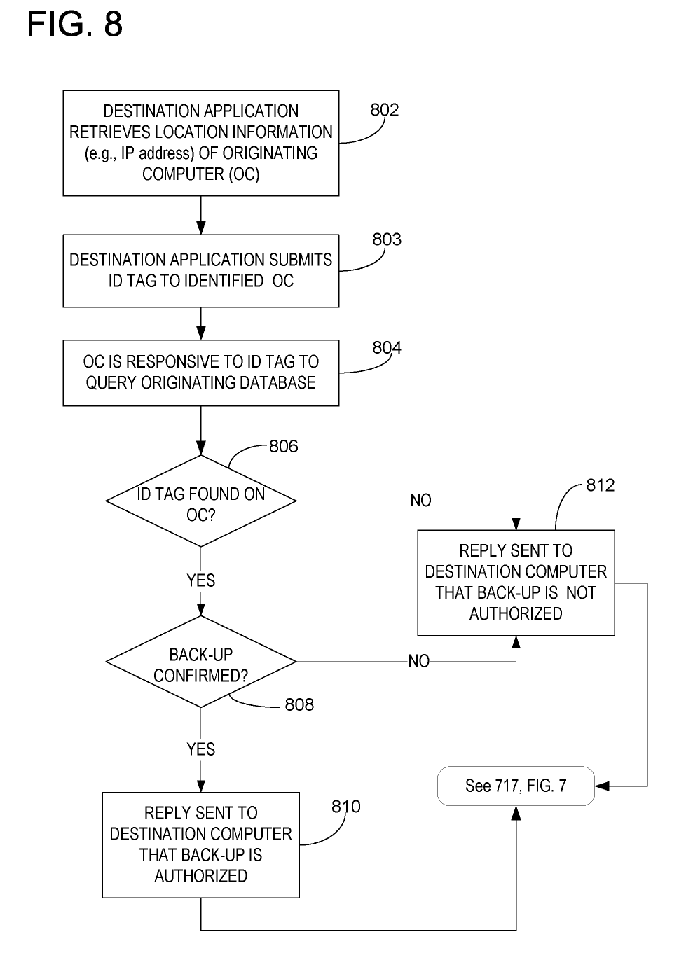

Referring now to FIG. 7, a flow chart illustrates a method for transferring back-up copies of one or more files from the originating computer 102 to a portable storage medium for delivery to the destination user. At 702, the originating user uses UI 120 to designate files (e.g., back-up copies) to transfer to a portable medium such as a CD. The originating application encrypts the designated files at 704. At 706, the encrypted files are transferred to the portable medium for storage. The portable medium is delivered to the destination user at 708. For example, the originating user sends the portable medium to the destination user via the United States Postal Service. At 710, the destination user executes storage instructions to upload the encrypted data stored on the portable medium to the destination computer for storage. The storage instructions determine whether sufficient storage space is available on the destination computer for storing the encrypted files stored on the portable medium at 712. If sufficient storage space is not available, the destination user is alerted that there is insufficient storage space at 714. If sufficient storage space is determined to be available at 712, the destination computer 104 executes authenticating instructions at 716 to authenticate (i.e., verify) that the originating computer 102 is authorized to store data on destination computer 104. As described above in reference to FIG. 2 and FIG. 4, authentication data includes a password previously defined by users 118, 130 and stored in the originating database 204 and destination database 304, respectively. If authentication data from the originating computer 102 does not match the authentication data stored on the destination computer 104, the originating computer 102 is not authenticated at 717, and the destination application 115 alerts the user 130 that the originating computer 102 is not authorized to store data at 718. If the entered password matches the authentication data stored on the destination computer 104, the originating computer 102 is authenticated at 717, and the encrypted files are transferred and stored on the destination computer at 720.

Referring now to FIG. 8, a flow chart illustrates an additional method for authenticating that the originating user 118 desires to transfer back-up copies of one or more files from the originating computer 102 to a portable storage medium for delivery to the destination user. In addition to password authentication data, authentication data includes ID tag data. As described above in reference to FIG. 6, an ID tag 605 is stored in the originating database 204 of the originating computer and stored on the portable computer readable medium 602. In this case, after the destination user 130 executes storage instructions to upload the encrypted data stored on the portable medium 602 to the destination computer 104 for storage, the destination application 115 executes authentication instructions (See FIG. 7). At 802, the destination application 115 retrieves identification data stored on the portable computer readable medium 602 to determine the location (i.e., IP address) of the originating computer 102. The destination computer 104 submits an authentication request, which includes the ID tag 605, to the identified originating computer 104 via the communication network at 803. At 804, the originating computer 114 is responsive to the received ID tag 605 to query the originating database 204 for that particular ID tag 605. If the ID tag 605 is found at 806, the originating application 114 prompts the originating user 118 to confirm that back-up of the listed files is desired at 808. If the user 118 confirms that back-up of the listed files is desired at 808, the originating application 114 sends a reply back to the destination computer 104 via the network 106 that the files are authorized for back-up at 810. If the ID tag 605 is not found at 806, or the user 118 does not confirm that back-up of the listed files is desired at 808, the originating application 114 sends a reply back to the destination computer 104 via the network 106 that the files are not authorized for back-up at 810.

### EHD with File Manager for Backing Up Files from Multiple Networked Computers

According to one embodiment of the invention, there are at least two scenarios in which an external hard drive (EHD) can be initially implemented as a back up platform:

(A) Plug a blank external hard drive (EHD) into a first computer which will use the EHD as a backup. The file manager is downloaded from the server to the first computer and to the EHD; OR

(B) the EHD can have a copy of the file manager pre-loaded on it or a blank EHD can be plugged into any computer and the file manager is downloaded from the server to the EHD. The pre-loaded EHD is plugged into a first computer to set up the EHD as a back up to the first computer.

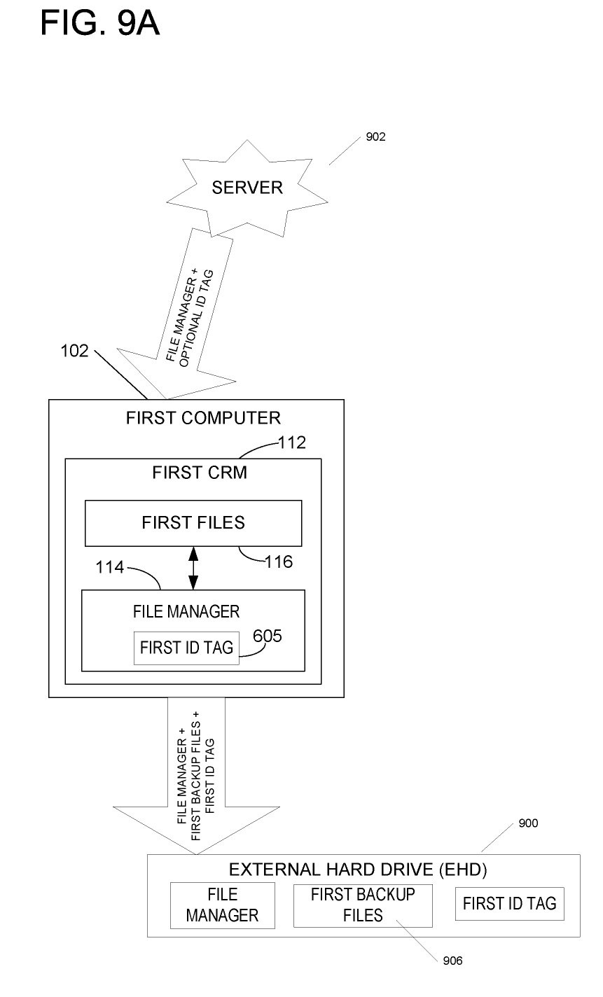

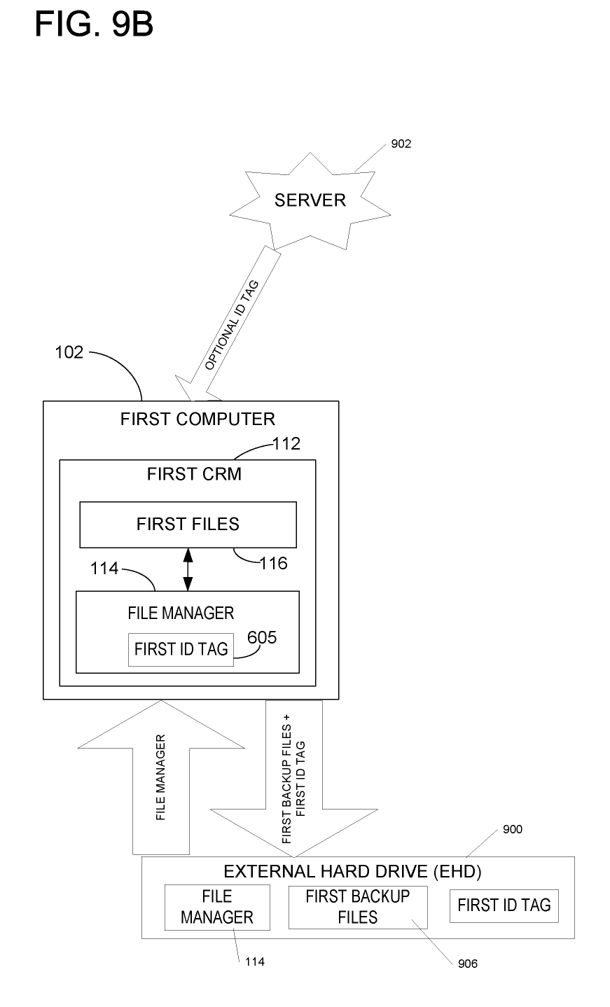

FIG. 9A illustrates scenario (A). Scenario (A) applies to the situation in which it has been determined that the first computer 102 will store its back up data on an EHD 900. After the file manager 114 is downloaded from a server 902 into the first computer and into the EHD, the file manager executes instructions and gives the user the option to back up the first files 116 of the first computer to the EHD. The user executes the option and the file manager 114 registers the first computer 102 with the server 902 and copies the first files of the first computer to the EHD as first backup files 906. Optionally, a first ID tag 605 may be assigned to the first computer by the server and stored on the EHD 900 for use in authenticating and/or accessing the first computer, as noted herein.

FIG. 9B illustrates scenario (B). With regard to scenario (B), after the EHD 900 with a pre-loaded file manager 114 is plugged into a first computer 102, the file manager executes instructions and gives the user the option to back up the first files 116 of the first computer to the EHD. The user executes the option and the file manager 114 is copied from the EHD to the first computer. The file manager copies the files of the first computer to the EHD and optionally registers the first computer with the server 902. Optionally, a first ID tag 605 may be assigned to the first computer by the server and stored on the EHD 900 for use in authenticating and/or accessing the first computer, as noted herein.

From this point forward with regard to either scenario, the system and method are the same regardless whether the EHD was implemented as a backup under scenario (A) or (B). In general, the EHD is moved to a location remote from the first computer and is plugged into a remote computer (remote from the first computer and connected to the first computer via a network). When the EHD is plugged into the remote computer, the EHD is available to receive a backup from the first computer to back up any revised or new first files on first computer. When the file manager on the first computer executes back up instructions, it locates the EHD via the network that connects the first computer and the remote computer. Optionally, the EHD may alert the server of the location of the EHD and is available to receive a backup from the first computer to back up any revised or new first files on first computer.

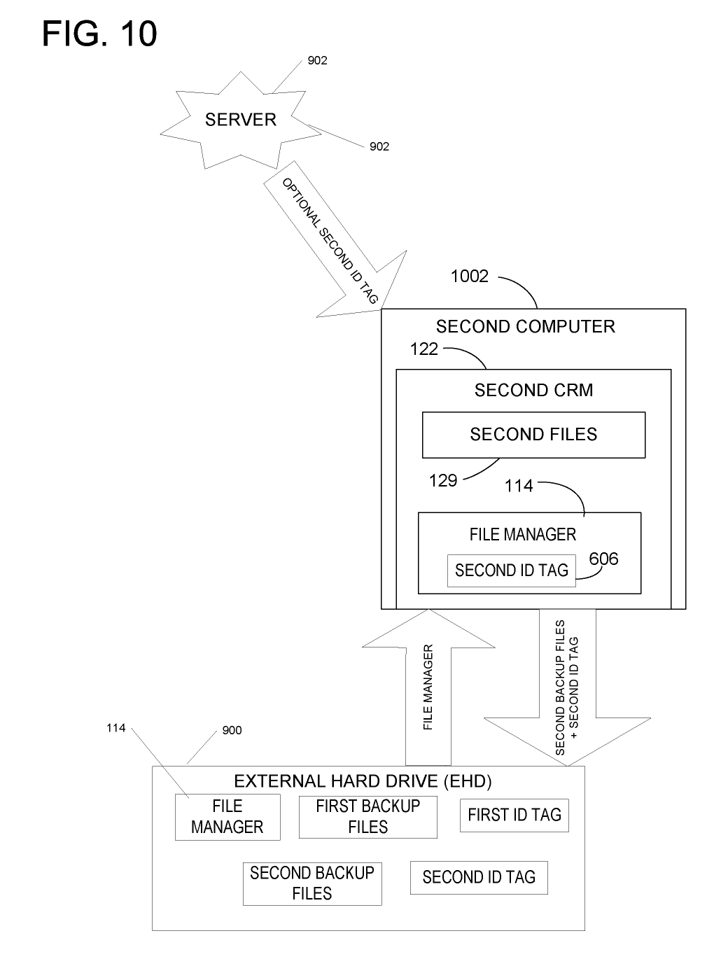

Referring to FIG. 10, when the EHD is plugged into a second computer 1002, the file manager 114 on the EHD executes instructions and gives the user the option to back up second files 129 of the second computer 1002 to the EHD 900. The user executes the option and the file manager is copied to the second computer. The file manager Optionally, the file manager registers the second computer with the server 902 and copies the files of the second computer to the EHD. Optionally, a second ID tag 606 may be assigned to the second computer by the server and stored on the EHD 900 for use in authenticating and/or accessing the first computer, as noted herein.

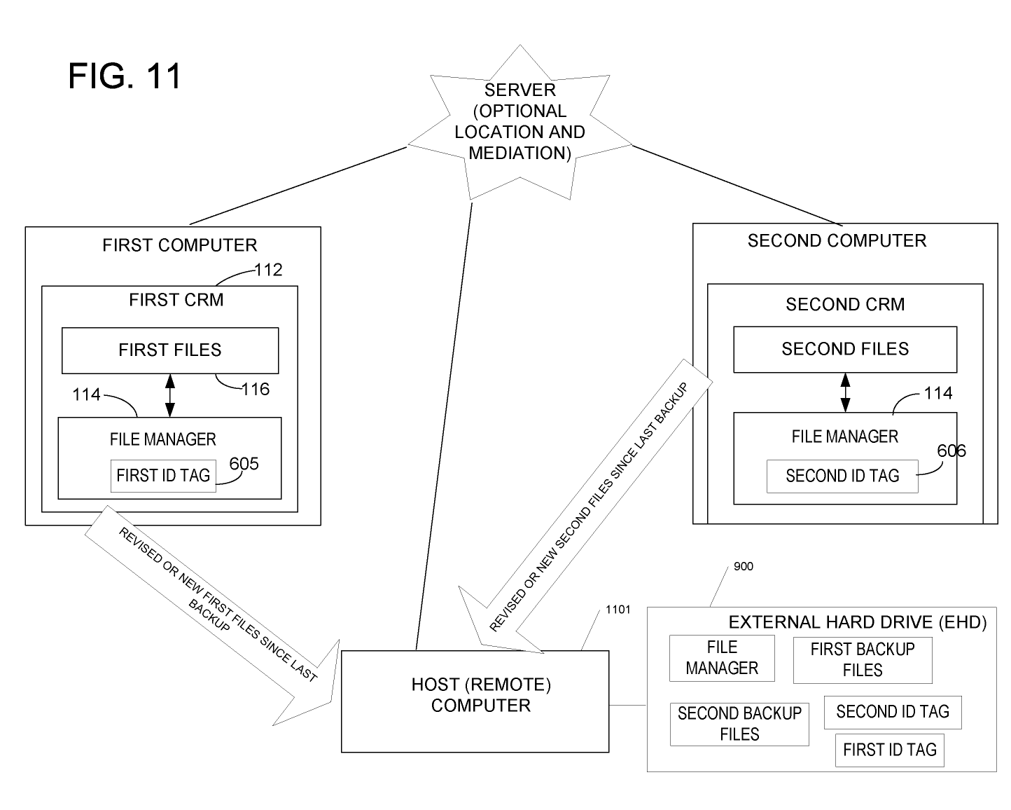

Thereafter, referring to FIG. 11, the EHD is moved to an offsite location remote from the first and second computers and is plugged into a host or remote computer 1101 (remote from the first and second computers). When the EHD 900 is plugged into the remote computer, the EHD is available to receive backup data from the first or second computers to back up any revised or new first files on first or second computers. The file managers on each of the first and second computers periodically connect to the EHD via the remote computer and download updates to their backup files. Optionally, the EHD alerts the server of the location of the EHD to be available to receive backup data from the first or second computers to back up any revised or new first files on first or second computers.

This action of backing up the files occurs whenever the EHD is available to the first or second computers. The EHD is available whenever it is plugged into a remote, host computer that has access to a network which connects the computers, such as the Internet. The connection between the host computer and the first and second computers can be established directly or the server can be optionally used to locate the host computer, to authenticate the computers and/or to otherwise mediate the connection between the host computer and the first and second computers. Backup data need not be handled by the server and in general would flow to the host computer from the first and second computers, although some embodiments may opt to have some or all data flow through the server.

One advantage is that the initial backup may occur via a USB port which is faster than initially setting up a first computer to back up via a network to a host computer remote from the first computer. In this later case, the initial back up data must be transferred via the network link such as the Internet, which can be slower than a USB port transfer. Thus, a large amount of initial data can be quickly backed up from the first computer into an EHD, which is then removed from the first computer to a remote location.

Another advantage occurs when data has to be restored. Since the backup data is stored in an EHD, the EHD can be plugged into the computer being restored or to a new computer taking the place of a previous computer. Since the EHD may be directly connected via a USB, even large amounts of data can be quickly transferred and restored.

Another advantage is that this provides individuals and/or small businesses with a means of easily establishing a remote storage location.

Thus, whenever the EHD is plugged into a third computer, it is ready to receive back ups. Optionally, it is connected to the first and second computers via the server to back up any revised or new files on first and second computers. In addition, when the EHD is plugged into the third computer, the file manager on the EHD executes instructions and gives the user the option to back up the third files of the third computer to the EHD. The number of computers that can be set up to use the EHD as a host can be limited or controlled according to the amount of memory of the EHD that is available.

### EXAMPLES

In this way, a user of multiple computers can back up all of the user's files on one external hard drive (EHD). For example, an individual with a home desktop, a laptop and a work desktop can use one EHD for backing up all three computers. The individual plugs an EHD into the home desktop and opts to back up the home desktop files on the EHD. The file manager copies the home desktop files to the EHD and optionally registers the home desktop with the server. The individual plugs an EHD into the laptop and opts to back up the laptop files on the EHD. The file manager copies the laptop files to the EHD and optionally registers the laptop with the server. The individual plugs an EHD into the work desktop and opts to back up the work desktop files on the EHD. The file manager copies the work desktop files to the EHD and registers the work desktop with the server. Assuming all three computers have access to a network such as the Internet, as long as the EHD is plugged into any computer with Internet access, all files of all three computers may be periodically backed up. Thus, the user can plug the EHD into a friend's computer which is remote from his home and work computers.

Thus, a peer to peer connection is established between the first and/or second computers and the host computer. However, the first and second computers do not necessarily have a backup relationship with host computer. In general, each of the first and second computers has a backup relationship with the EHD. One option is that the EHD can dump or migrate the EHD first backup files onto the second computer to establish the second computer as a backup to the first computer. In this option, the first and second computers have a backup relationship.

Another example: The EHD is used in an office environment with 4 desktop computers and 5 laptop computers. All computers are protected wherever they are located. The laptops can travel anywhere, and if connected to the Internet, they can backup to the EHD without any further configuration. The EHD can be moved to any Internet enabled computer, plugged in, and all computers will be able to find it either directly or via the server.

Another example: In a household, Mom and Dad and a child each have a laptop and are out of town separately yet all have their laptop data protected by connecting their laptop to the Internet and downloading a backup to the EHD.

In summary, some of the advantages noted herein and in the above examples include:

1. Initial back up is computer to EHD via USB so transfer is fast.

2. Restoration is from EHD to computer via USB or from EHD to CRM to computer so transfer is fast.

3. EHD may eliminates second user intervention.

4. Can take EHD anywhere.

5. multiple computers can be backed up to one EHD.

Without departing from the scope of the invention, other options include the following:

1. The first and second computers can share files. For example, some or all first files saved to the EHD may be accessible by the second computer.

2. Back up file copies need not be encrypted.

3. Encrypted second files can be copied by the first computer to a CRM and the CRM is sent to the second computer to restore its files by accessing the encrypted files on the CRM.

4. Profile information of each user may be stored on the server. In the event of a lost or stolen computer, the user may purchase a new computer, and access the stored files on the EHD using the profile information stored on the server.

5. The file manager may be optionally configured to back up files of any computer that is networked to a computer to which the EHD is plugged.

6. Without naming partners or peers, the EHD can be located anywhere there is an Internet connection and the users will be able to backup to the EHD without any further action.

7. Seamless offsite storage is initially enabled without the initial online transfer time.

8. Restoration of backup files can also be accomplished to eliminate online transfer time.

For purposes of illustration, programs and other executable program components, are illustrated herein as discrete blocks. It is recognized, however, that such programs and components reside at various times in different storage components, and are executed by the data processor(s) of the devices.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive an mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1: A method for transferring back-up copies of first files from a first computer to an external hard drive (EHD) and for transferring back up copies of second files from a second computer to the EHD, wherein an Internet connection periodically connects the first computer and the second computer, said method comprising:
Connecting the EHD including a file manager to the first computer wherein the file manager backs up the first files to the EHD;
Connecting the EHD including the file manager to the second computer wherein the file manager backs up the second files to the EHD;
Connecting the EHD to a third computer connected to the Internet;
Backing up the first files to the EHD via the Internet connection between the first computer and the third computer; and
Backing up the second files to the EHD via the Internet connection between the second computer and the third computer.

2. The method of claim 1 wherein the file manager is loaded to the EHD prior to connecting the EHD to the first computer.

3. The method of claim 2 wherein the file manager is loaded from the EHD to the first computer.

4. The method of claim 1 wherein the file manager is loaded to the EHD from a server via the first computer and the file manager is loaded to the first computer from the server.

5. The method of claim 1 further comprising restoring files from the EHD to the first computer by connecting the EHD to the first computer.

6. The method of claim 1 wherein a server mediates a connection between the EHD and the first and second computers.

7. A method of claim 1 for facilitating the transfer of back-up copies of one or more files from the first computer to the EHD; comprising:
designating files from the first computer for which back-up copies will be transferred to the EHD;
selectively transferring the designated files from the first computer to the EHD via a USB port; and
storing, at the EHD, the transferred files.

8. The method of claim 1, wherein first backing up files include encrypting the files.

9: A method for transferring back-up copies of first files from a first computer to an external hard drive (EHD), wherein an Internet connection periodically connects to the first computer, said method comprising:
Copying a file manager to the EHD;
Connecting the EHD including the file manager to the first computer wherein the file manager is copied to the first computer and wherein the file manager backs up the first files to the EHD; and
Connecting the EHD including the file manager to a remote computer connected to the Internet wherein the copy of the file manager on the first computer backs up the first files to the EHD via the Internet connection between the first computer and the remote computer.

10. The method of claim 9 wherein the file manager is copied to the EHD prior to connecting the EHD to the first computer.

11. The method of claim 10 wherein the file manager is copied from the EHD to the first computer after the file manager is copied to the EHD.

12. The method of claim 9 wherein the file manager is copied to the EHD from a server via the first computer and the file manager is copied to the first computer from the server.

13. The method of claim 9 further comprising restoring files from the EHD to the first computer by connecting the EHD to the first computer.

14. The method of claim 9 wherein a server mediates a connection between the EHD and the first and remote computers.

15. A system to back up first files on a first computer which is periodically connected to a network which is connected to a second computer, comprising:
An external hard drive (EHD);
A file manager on the EHD wherein the file manager has instructions to back up the first files on the first computer to the EHD when the EHD is initially connected to the first computer; and
Wherein when the EHD is connected to a second computer, the file manager has instructions to back up the first files to the EHD via the network and the second computer.

16. The system of claim 15 wherein the file manager registers the first computer with a server; and wherein when the EHD is connected to a second computer, the server locates the EHD connected to the second computer and the first files are backed up to the EHD via the network and the second computer.

17. The system of claim 15 wherein the file manager is loaded to the EHD prior to connecting the EHD to the first computer.

18. The system of claim 17 wherein the file manager is loaded from the EHD to the first computer.

19. The system of claim 15 wherein the file manager is loaded to the EHD from a server via the first computer and the file manager is loaded to the first computer from the server.

20. The system of claim 15 wherein the file manager has instructions to restore files from the EHD to the first computer when the EHD is connected to the first computer.

21. The system of claim 15 wherein the file manager has instructions to use a server to mediate a connection between the EHD and the first and second computers.
